(19) United States
(12) Patent Application Publication
(10) Pub. No.: US 2010/0089143 A1
(43) Pub. Date: Apr. 15, 2010

(54) RESERVOIR MONITORING APPARATUS AND METHOD

(75) Inventor: Helge Brandsaeter, Hamresanden (NO)

Correspondence Address: Edmonds Nolte, PC, 16815 ROYAL CREST DRIVE, SUITE 130, HOUSTON, TX, 77058, US

(73) Assignee: OCTIO Geophysical AS

(21) Appl. No.: 12/248,111

(22) Filed: Oct. 9, 2008

(51) Int. Cl. E21B 47/18; G01P 15/00

(52) U.S. Cl. 73/152.55; 73/152.58; 73/514.05

(57) ABSTRACT

An apparatus for monitoring a reservoir. The apparatus can include a tube that is conveyable in a well, penetrating the reservoir. The apparatus can further include an expandable member coupled to the tube. The expandable member can expand upon exposure to a downhole trigger. A sensor can be coupled to the expandable member.

### BACKGROUND

1. Technical Field

The present disclosure generally relates to reservoir monitoring and in particular to methods and apparatus for contacting a well wall with one or more sensors.

2. Background Information

Well logging, whether from wireline or drill stem, only provides a very limited amount of information about hydrocarbon reservoirs.

One method for monitoring a reservoir is seismic monitoring. Seismic monitoring can be performed with 3-D surveys. Most 3-D surveys are performed using temporary arrays of surface sources and receivers. However, long-term emplacement of the receivers can significantly lower data acquisition costs. The reliability of the data can also be improved with long term emplacement of receivers. Furthermore, if the receivers are placed in the field early surveys can be conducted on time intervals conducive to reservoir management. Whereas, when temporary receivers are used the surveys are usually conducted based on data acquisition constraints. Therefore, a need exists for a reservoir monitoring apparatus that allows for long term monitoring and that can be configured to detect three dimensional acoustic or seismic wave data.

### SUMMARY

The following presents a general summary of several aspects of the disclosure in order to provide a basic understanding of at least some aspects of the disclosure. This summary is not an extensive overview of the disclosure. It is not intended to identify key or critical elements of the disclosure or to delineate the scope of the claims. The following summary merely presents some concepts of the disclosure in a general form as a prelude to the more detailed description that follows.

Disclosed is an apparatus for monitoring a reservoir. The apparatus may include a tube that can be conveyed into a well penetrating the reservoir. The apparatus may also include an expandable member coupled to the tube. The expandable member may expand upon exposure to a downhole trigger. A sensor may be coupled to the expandable member.

An exemplary method for monitoring a reservoir can include conveying a sensor into a well. The sensors can be disposed on an expandable member. The expandable member can be exposed to a downhole trigger, and the expandable member can expand to move the sensor towards a well wall, upon exposure to the downhole trigger.

### BRIEF DESCRIPTION OF THE DRAWINGS

For a detailed understanding of the present disclosure, reference should be made to the following detailed description of the several non-limiting embodiments, taken in conjunction with the accompanying drawings, in which like elements have been given like numerals and wherein:

FIG. 1 illustrates a non-limiting example of a reservoir monitoring apparatus comprising a sensor;

FIG. 2 is a non-limiting example of a reservoir monitoring apparatus comprising a sensor module;

FIG. 3 is a non-limiting example of a reservoir monitoring apparatus configured to conduct downhole monitoring of a reservoir;

FIG. 4-FIG. 5 is a non-limiting detailed view of a reservoir monitoring apparatus configured to operate with a reservoir monitoring system;

FIG. 6 depicts an non-limiting embodiment of a sensor module with three sensors; and

FIG. 7 depicts an embodiment of a method for partially acoustically coupling a downhole sensor with a formation.

### DESCRIPTION OF EXEMPLARY EMBODIMENTS

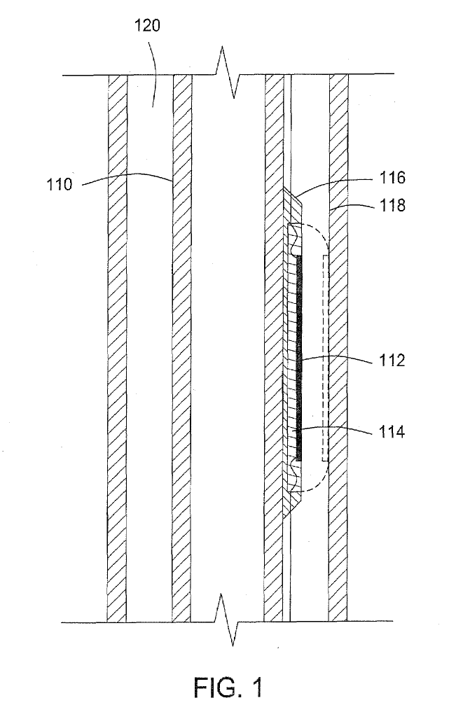

Referring initially to FIG. 1, a tube 110 with a sensor 112 is depicted. An expandable member 114 can be disposed between the tube 110 and the sensor 112. Each sensor 112 can be disposed proximate to at least one protrusion 116. The protrusions 116 can protect the sensor 112 when the expandable member 114 is in an unexpanded condition or substantially unexpanded condition. When the expandable member 114 is in an expanded condition the sensor 112 can abut a wall 118 of a well 120, for example as depicted in FIG. 1. In a non-limiting embodiment, the well 120 can be a cased well and in another non-limiting embodiment the well can be an open hole well.

In one or more embodiments, the sensor 112 can be a geophone, an accelerometer, or a combination thereof. Accelerometers can measure the three acoustic components of a wave field. The accelerometers can directly measure both compressional and shear waves directly. Accelerometers can detect accelerations, and can be highly sensitive at high frequencies. Accelerometers that have three-component acceleration measurements are commonly available. In one or more embodiments, the sensor 112 can be a geophone with particle velocity detectors, which can provide a three-component velocity measurement. Both geophones and accelerometers can be used to determine the direction of arrival of the incident elastic wave. In another non-limiting embodiment, the sensors can be Microelectromechanical systems (MEMS) sensors.

The expandable member 114 can be made from ethylene propylene diene monomer, styrene-butadiene, rubber, natural rubber, ethylene-propylene monomer, ethylene-vinyl acetate rubber, hydrogenated acrylonitrile-butadiene rubber, isoprene rubber, chloroprene rubber, polynorbornene, or combinations thereof. Those skilled in the art with the benefit of the present disclosure will recognize that the above list of materials is a non-exhaustive list and other materials can be used to make the expandable member. The expandable member 114 can have a thickness in a compressed condition from about one half of an inch to about one inch, and a thickness in a non-compressed condition from about three quarters of an inch to about two inches. In one or more embodiments, the expandable member 114 can be disposed between the two protrusions 116 and the sensor 112 can be disposed on the portion of the expandable member 114 opposite the tube 110.

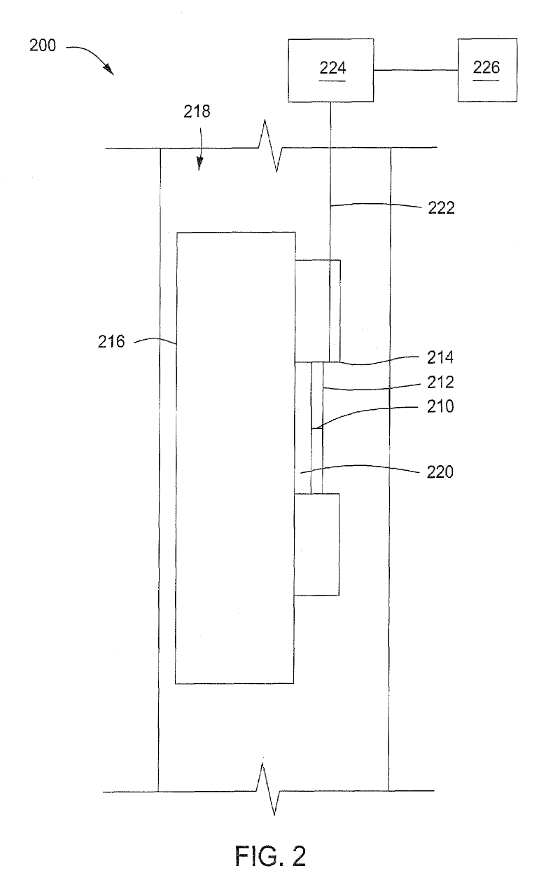

In FIG. 2 a detailed view of, a non-limiting embodiment, the apparatus for monitoring a reservoir 200 is illustrated. The apparatus for monitoring a reservoir 200 can include a sensor module 210. The sensor module 210 can have at least one sensor 212. The sensor module 210 can be disposed between two protrusions 214. The two protrusions 214 can protect the sensors module 210 from damage as the tube 210 is put into a well 218. However, it is possible, that in one or more embodiments, that only one protrusion 214 is used to protect the sensor module 210, sensor 212, or combinations thereof. The two protrusions 214 can be integral with or otherwise coupled to the tube 216. In one or more embodiments, the two protrusions 214 can be a berth. The two protrusions 214 can be integral with the tube 216. In one or more embodiments, the two protrusions 214 can be attached to the tube 216 by mechanical means. The two protrusions 214 can extend slightly past the sensor module 210, the sensor 212, or combinations thereof. The two protrusions 214 can be spaced apart up to 50 cm, if required the spacing can be even smaller or larger. The length of each of the protrusions 214 can be long enough to protect the sensor module 210, the sensor 212, or combinations thereof from impact, and at the same time short enough to allow installation of the tube 216 in the well 218.

An expandable member 220 is depicted, in this non-limiting embodiment, filling the volume between the two protrusions 214, as well as coupling the sensor module 210, the sensor 212, or combinations thereof to the tube 216. The expandable member 220 is in a compressed condition. The sensor module 210 can be in communication with a cable 222. The cable 222 can be in communication with an electronic device 224, a recorder 226, or combinations thereof. The electronic device 224 can be a transmitter or can include a transmitter.

The cable 222 can provide some support to the sensor module 210, sensor 212, or combinations thereof. The cable 222 can be encased in steel or another hard stiff material. For example, the cable 222 can be disposed within a steel tube. When the expandable member 220 is in an expanded condition, the sensor module 210 and sensor 212 can be at least partially acoustically decoupled from the tube 216 by the expandable member 220. Partially acoustically decoupled means that the vibrations traveling through the tube 216 to the sensor module 210, the sensor 212, or combinations thereof are dampened. It is possible, that the expandable member 220 can fully insulate the sensor module 210, the sensor 212, or combinations thereof from the vibrations traveling through the tube 216 to the sensor module 210, the sensor 212, or combinations thereof.

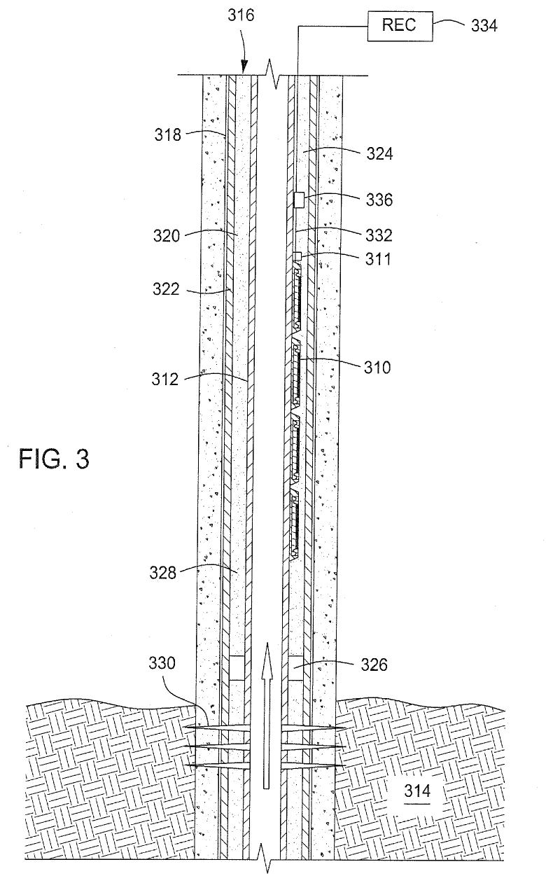

FIG. 3 depicts a non-limiting embodiment, of one or more sensor modules 310 (four are shown) on a tube 312 configured to conduct horizontal downhole monitoring of a reservoir, such as reservoir 314, as depicted in FIG. 3. The tube 312 can be a production string, a work string, a service string, or another common downhole string. The tube 312 can be disposed in a well 316, which is depicted, in this non-limiting embodiment, as a cased hole, but the well 316 can be an openhole. The well 316, in this non-limiting example, can include a casing 318. The casing 318 can be a two-part casing with a liner portion 320 and a cement portion 322. An annulus 324 can be between the tube 312 and the casing 318. The tube 312 can be in communication with one or more reservoirs, such as reservoir 314.

One or more packers 326 can be disposed along the tube 312. Additional packers 326 may be disposed along the tube 312. The additional packers 326 can define other production zones and seal off the bottom of the well 316. One or more of the packers 326 may be disposed in the annular region above the producing reservoir to prevent reservoir fluid from flowing in the annular region. Those skilled in the art with the benefit of the present disclosure will recognize that multiple reservoirs may be traversed by a well, and that the arrangement shown in FIG. 3 may be expanded as desired for multiple reservoirs. In multiple reservoir arrangements, packers 326 may be installed above and below each traversed reservoir to isolate each reservoir.

A portion of the casing 318 can have perforations 330. The perforations 330 can provide fluid communication between the tube 312 and reservoir 314. During production, the annulus 324 usually contains annulus fluid 328. The annulus fluid 328 can be water, liquid hydrocarbons, gas, or combinations thereof.

In the depicted embodiment, sensor modules 310 may have a transmitter 311 that can be in communication with a cable 332. The cable 322 is depicted, in this non-limiting embodiment, connected to a recorder 334. The recorder 334 can include an electronic device 336, which can digitize the signals, or in the alternative as depicted in FIG. 3, the electronic device 336 can be disposed along the tube 312 in communication with the recorder 334. In one or more embodiments the electronic device 336 can be a transmitter and can replace the transmitter 311. In one or more embodiments, the electronic device 336 can be in communication with the transmitter 311, as depicted in FIG. 3, or can include the transmitter 311 (not shown). The electronic device 336 can be in communication with the recorder 334, the sensor modules 310, or a combination thereof. In one or more embodiments, the electronic device 336 can include a converter that produces a signal indicative of a sensor output.

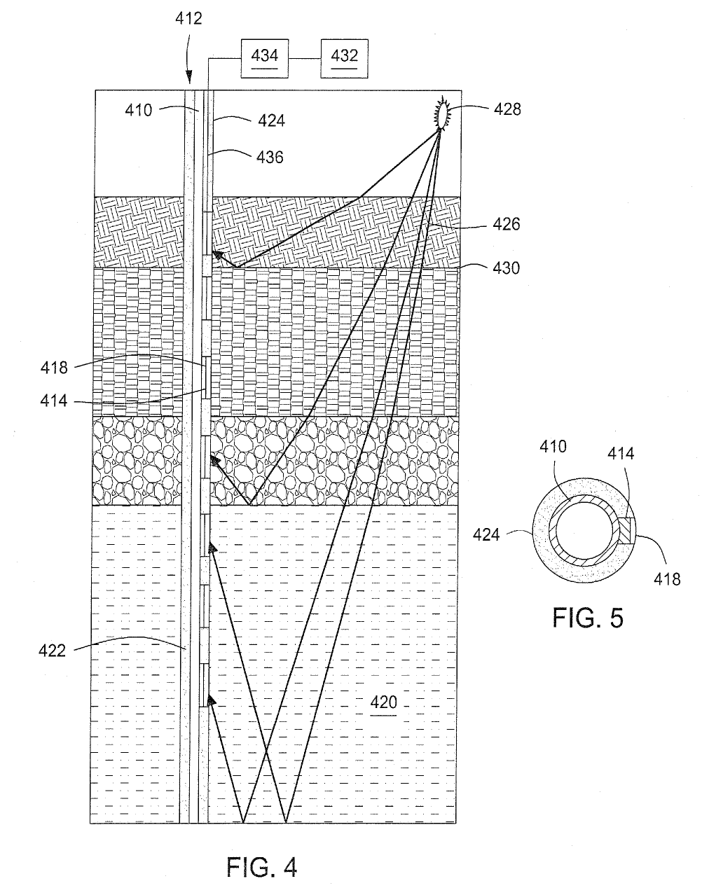

FIG. 4 and FIG. 5 depict and embodiment of the tube 410 installed into well 412 with at least one expandable member 414, one or more sensor modules 418. The tube 410, in this non-limiting embodiment, is depicted fully installed and the apparatus for monitoring a reservoir 420. The sensor modules 418 can include one or more sensors configured to measure seismic waves. The expandable member 414 is depicted in an expanded condition, due to exposure to a downhole trigger. The downhole trigger can be exposure to an annulus fluid 422, for example crude oil, water, or gas. The sensor module 418 can contact the wall 424 of the well 412, as depicted in this non-limiting embodiment. The sensor module 418 can then receive signals 426 from a wave source 428. The wave source 428 can be an air gun, an explosive, a mechanical vibration machine, or combinations thereof.

The signals 426 sent from the wave source 428 can propagate through a medium, which can be ground or water, and can spread out as they move deeper and can reflect off of reflectors 430. The signals 426 sent back by the reflectors 430, can be received by the sensor modules 418. The signals 426 received by the sensor modules 418 can have noise reduction due to the acoustic decoupling from the tube 410. The noise reduction can result from the vibration damping provided by the expanded expandable member 414. Furthermore, the signals 426 received by the sensor modules 418 can be of high quality and fidelity due to the sensor modules 418 contact with the wall 424 of the well 412. When the sensor modules 418 receive the signals 426 the sensor modules 418 can send information to a recorder 432, the electronic device 434, or combinations thereof. The electronic device 434 can be a transmitter or can include a transmitter. The information can be sent from the modules 418 to the recorder 432 via a cable 436 or by other forms of communication, such as wireless communication.

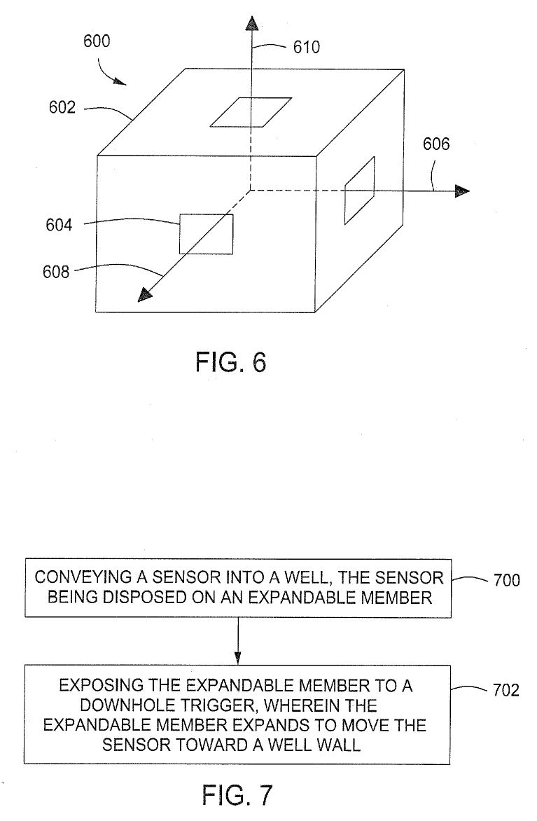

FIG. 6 depicts a non-limiting embodiment of a sensor module 600. The sensor module 600 can include a housing 602. Three sensors 604 can be disposed within the housing 602. One skilled in the art with the benefit of this disclosure will know that less than three sensors 604 or more than three sensors 604 can be disposed in the housing 602. The sensors 604 can be aligned to measure wave fields in three directions. For example, a sensor 604 can be disposed along an x-axis 606, another sensor 604 can be disposed along a z-axis 608, and a third sensor 604 can be disposed along a y-axis 610.

The housing 602 can have a tubular shape, a square shape, an elliptical shape, or similar shape. An electronic device, such as the electronic device 336 described above and shown in FIG. 3 can be integral with the housing 602. In one or more embodiments, the electronic device can be independent of the housing 602 but in communication with the sensor module 600, with selective individual sensors 604, or combinations thereof. The communication between the electronic device, the sensor modules 600, the sensors 604, or combinations thereof can be selective. A plurality of sensor modules 600 can be disposed along a tube, for example as depicted in FIGS. 3, 4, and 5.

A reservoir can be monitored in many ways. In most cases it is desirable to at least partially acoustically couple a sensor to a formation. An exemplary method for at least partially acoustically coupling a sensor to a formation is depicted in FIG. 7. One or more embodiments of the method can include conveying a sensor, which can be disposed on an expandable member, into a well, at 700.

The method can also include exposing the expandable member to a downhole trigger. The expandable member can expand upon exposure and move the sensor towards a well wall, at 702. A, non-limiting, example, of how a tube, which can be made of several pieces of tubing threaded together, can be conveyed into a hole can include disposing an expandable member on at least one portion of the tube. Disposing at least one sensor on the expandable member. One or more packers can be disposed along side the tube, and the tube can be placed in the annulus of well hole. The expandable member can contact an annulus fluid. When the expandable member contacts the annulus fluid it can start to expand. The expandable member can expand, which can cause the sensors to at least partially acoustically couple to the formation, such as a well wall. However, it is possible that it can take up to several months for the sensors to at least partially acoustically couple with the formation; for example, it may take several months for the sensor to contact the well wall; of course, the sensors can contact the well walls quicker, depending on the rate of expansion of the expandable member. The sensors can receive and transmit information that will allow for monitoring of the reservoir.

In one or more embodiments, one or more of the sensors can be used to monitor seismic energy. The seismic energy can include p-wave, s-wave, or combinations thereof. Having described above the several aspects of the disclosure, one skilled in the art will appreciate several particular embodiments useful in the monitoring of a reservoir.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions.

What is claimed is:

1. An apparatus for monitoring a reservoir comprising:
a tube that is conveyable into a well penetrating the reservoir;
an expandable member coupled to the tube, the expandable member expands upon exposure to a downhole trigger; and
a sensor coupled to the expandable member.

2. An apparatus according to claim 1, wherein the expandable member includes ethylene propylene diene monomer, styrene-butadiene, rubber, natural rubber, ethylene-propylene monomer, ethylene-vinyl acetate rubber, hydrogenated acrylonitrile-butadiene rubber, isoprene rubber, chloroprene rubber, polynorbornene, or combinations thereof.

3. An apparatus according to claim 1, wherein the sensor includes a geophone, an accelerometer, or a combination thereof.

4. An apparatus according to claim 1, wherein the sensor includes a MEMS sensor.

5. An apparatus according to claim 1, wherein the sensor includes a sensor module that include a plurality of sensors.

6. An apparatus according to claim 1, wherein the sensor comprises a plurality of sensor modules disposed along the tube.

7. An apparatus according to claim 1, wherein the sensor contacts the well wall when the expandable member expands.

8. An apparatus according to claim 1, wherein the sensor is at least partially acoustically decoupled from the tube by the expandable member.

9. An apparatus according to claim 1, wherein the downhole trigger comprises fluid.

10. An apparatus according to claim 9, wherein the fluid comprises a liquid, a gas, or a mixture of liquid and gas.

11. An apparatus according to claim 1, wherein the tube comprises a protrusion disposed proximate the sensor for protecting the sensor from damage while the tube is conveyed into the well.

12. An apparatus according to claim 1, further comprising an electronic device in communication with the sensor.

13. An apparatus according to claim 12, wherein the electronic device includes a converter that produces a signal indicative of a sensor output.

14. An apparatus according to claim 1, further comprising a transmitter that transmits geophysical information to a surface location.

15. A method for at least partially acoustically coupling downhole sensors with a formation comprising:
conveying a sensor into a well, the sensor being disposed on an expandable member, and exposing the expandable member to a downhole trigger; wherein the expandable member expands to move the sensor towards a well wall.

16. A method according to claim 15, wherein the sensor contacts the well wall after the expandable member is exposed to the downhole trigger.

17. A method according to claim 15, further comprising monitoring seismic energy using the sensor.

18. A method according to claim 17, wherein the seismic energy includes p-waves, s-waves, or combinations thereof.

19. A method according to claim 17, further comprising sensing acceleration.

20. A method according to claim 17, further comprising sensing particle velocity.
